(19) United States
(12) Patent Application Publication
(10) Pub. No.: US 2006/0094353 A1
(43) Pub. Date: May 4, 2006

(54) Mobile communication terminal and method therefore

(76) Inventors: Peter Dam Nielsen, Kgs. Lyngby (DK); Christian Kraft, Hvidovre (DK)

Correspondence Address: GEZA ZIEGLER;Perman and Green, LLP, 425 Post Rd., Fairfield, CT, 06824, US

(21) Appl. No.: 10/978,959

(22) Filed: Nov. 1, 2004

(51) Int. Cl. H04B 7/14

(52) U.S. Cl. 455/17

(57) ABSTRACT

A method for providing an international telecommunication number comprising a plurality of digits corresponding to at least a country code, from a mobile telecommunication terminal to a base station, is disclosed. The method comprises receiving a plurality of digits in a control unit in the mobile telecommunication terminal, said digits identifying a subscriber terminal in a telecommunication network, and determining if one or more of the plurality of digits correspond to a country code. If the one or more of the plurality of digits do not correspond to a country code, an international telecommunication number is created by adding a country code to the plurality of digits, whereupon the international telecommunication number is transferred to the base station.

### BACKGROUND OF THE INVENTION

1. Field of the Invention

The present invention generally relates to mobile telecommunication terminals, and more specifically to methods and apparatus for facilitating communication by means of mobile telecommunication terminals when roaming.

2. Brief Description of Related Developments

By the increased use of mobile telecommunication terminals many people are given the opportunity to get in contact with each other practically anywhere at any time. The contact may take the form of e.g. a voice call or a short text message. Examples of systems for providing this kind of mobile services are DAMPS, PCM, GSM and UMTS.

A person using a mobile telecommunication terminal registers the terminal in a home network the first time he or she uses the terminal for e.g. placing a phone call. The home network usually extends at least within the boundaries of the country in which the user registers the mobile telecommunication terminal. In the situation where the user of the mobile telecommunication terminal travels abroad, the home network service provider normally offers the possibility of using the mobile telecommunication terminal in the foreign country by the provision of roaming, wherein a local network service provider in the foreign country provides the mobile telecommunication services to the mobile telecommunication terminal.

Even though roaming makes it possible to use the mobile telecommunication terminal in a foreign country, it is very important that the user of the mobile telecommunication terminal provides the local network operator with correct destination subscriber numbers when placing a call. An error in the destination subscriber number will inevitably result in an erroneous connection or no connection at all.

Every subscriber in a network is assigned a number that is unique within that specific (local) network. The International Telecommunication Union (ITU) has established a numbering plan and numbering structure for both land-based and mobile telecommunication numbers. For example the ITU recommendation E.164 specifies the structure of telecommunication numbers throughout the world, wherein an international telecommunication number is specified to comprise a maximum of 15 digits organized as 1-3 digits corresponding to a country code which is used when dialing to a particular country from another country, and 12-14 digits corresponding to a subscriber number. The subscriber number may comprise a national destination code (NDC) which is used to make a call within a specific country from e.g. one city to another. Moreover, the international telecommunication number is normally used in combination with an international access code which is needed to dial a call from a country to another country.

The above implies that a person trying to make a call from e.g. a country with the country code 46 (Sweden) to a country with the country code 45 (Denmark) must add 0045, corresponding to the international access code and the country code of Denmark, to the beginning of the destination subscriber number in order to direct the call to Denmark. Otherwise the telecommunication network system will assume that the subscriber wants to place a call to a destination subscriber within the same (46) country.

Mobile telecommunication terminals are normally provided with a programmable list of telecommunication numbers, to which the user of the mobile telecommunication terminal adds subscriber numbers for later retrieval. If the user wants to use the list, or address book as it is sometimes referred to, when roaming, the user must have stored the telecommunication numbers as international telecommunication numbers in the list when retrieving a number for placing a call, or the call will not be established correctly. Many persons do not know the structure of international telecommunication numbers, and consequently do not store the telecommunication numbers in the correct format when adding numbers to the list. It is a well established fact that a large percentage of all incorrectly placed calls has its origin in erroneously entered telecommunication numbers, i.e. the user enters a number lacking a country code.

U.S. Pat. No. 6,751,481 addresses the problem that different countries provides different international access codes. A mobile telephone according to this document always keeps track of its location when a user places a call and exchanges a pre-stored international access code with the international access code of the current location. By this arrangement a call placed by a user of the mobile telephone is always correctly directed from the country in question (in e.g. the GSM system this procedure corresponds to replacing the international access code with a “+”-sign in the beginning of an international telecommunication number). However, this document does not address the problem of directing the call to the correct destination country.

There is hence a need for a reliable method for correctly placing a call when roaming even though the number entered directly or retrieved from an address book lacks a country code.

### SUMMARY OF THE INVENTION

An object of the present invention is to overcome the above described problems of the known technologies in regard to establishing a communication between a mobile telecommunication terminal and a subscriber station when roaming.

A particular advantage of the present invention is the provision of a simple and reliable method for automatic creation of an international telecommunication number when a user of the mobile telecommunication terminal is trying to establish a communication with another subscriber station.

A particular feature of the present invention relates to the provision of a mobile telecommunication terminal for creating the international telecommunication number.

The above objects, advantages and features together with numerous other objects, advantages and features, which will become evident from the detailed description below, are obtained according to a first aspect of the present invention by a method for providing an international telecommunication number, comprising a plurality of digits corresponding to at least a country code, from a mobile telecommunication terminal to a base station. The method comprises:

receiving a plurality of digits in a control unit in the mobile telecommunication terminal, said digits identifying a subscriber terminal in a communication network,

determining if one or more of the plurality of digits correspond to a country code,

if the one or more of the plurality of digits do not correspond to a country code, creating an international telecommunication number by adding a country code to the plurality of digits, and

transferring the international telecommunication number to the base station.

A user of the mobile telecommunication terminal does hence not have to pay attention to whether or not the received digits comprise a country code or not in order to set up a call between the mobile telecommunication terminal and the subscriber terminal.

According to one embodiment the country code is read from the memory in the mobile telecommunication terminal. A user or manufacturer of the mobile telecommunication terminal may hence add country codes to the memory after manufacture of the mobile telecommunication terminal. By reading the country code from a memory the added country codes may also be used in addition the any pre-stored country codes.

According to one embodiment the control unit receives the digits from a memory in the mobile telecommunication terminal. Even though the person trying to set up the call is aware of the importance of providing a country code to the base station, a person who has previously used the mobile telecommunication terminal and stored the digits may be unaware of this importance. By reading the digits from the memory and adding a country code to the digits, an erroneously stored telecommunication number, i.e. a number lacking a country code, will nevertheless correctly establish a communication between the mobile telecommunication terminal and the subscriber station.

According to one embodiment the control unit receives the digits from an input unit, such as a keyboard, in the mobile telecommunication terminal. A user who is unaware of a need for providing a country code to the base station will anyway be able to correctly establish a communication between the mobile telecommunication terminal and a subscriber station.

According to one embodiment the mobile telecommunication terminal is associated with a subscription of services from a home network, wherein the method comprises:

determining in which country the mobile telecommunication terminal is located

determining if the current location of the mobile telecommunication terminal corresponds to the country of the home network,

wherein said creation of the international telecommunication number is performed only if the current location of the mobile telecommunication terminal does not correspond to the country of the home network.

The country code will hence only be added if the mobile telecommunication terminal is not located in its home network. Unnecessary processing of the telecommunication number is hence avoided.

According to one embodiment the creation of the international telecommunication number is performed by reading a predefined country code from a memory in the mobile telecommunication terminal and adding said country code to the plurality of digits. The base station may hence be provided with a default country code, e.g. the country code corresponding to the country of the home network, which increases the chances of successfully establishing a communication.

According to one embodiment the method comprises determining in which country the mobile telecommunication terminal is located by means of a satellite positioning system, such as GPS (Global Positioning System) or Galileo. The location of the mobile telecommunication terminal may hence be determined irrespective of which network the mobile telecommunication terminal is operating in, i.e. irrespective of whether or not other components of the network provides this information.

According to one embodiment the method comprises:

receiving a mobile telecommunication network ID from a base station, and

determining in which country the mobile telecommunication terminal is located by means of the received mobile telecommunication network ID.

If the mobile telecommunication terminal is able determine its current location by means of a network ID, the design of the mobile telecommunication terminal will become simpler and hence cheaper.

According to one embodiment the method comprises presenting, on a display on the mobile telecommunication terminal for selection, data identifying one or more countries corresponding to one or more country codes if it is determined that the telephone number does not comprise a country code.

The user of the mobile telecommunication terminal may hence select which country code to add to the digits, wherein the design of the mobile telecommunication terminal becomes simpler. Additionally, in case the control unit in the mobile telecommunication terminal selects which country code to add, the user is given an opportunity to verify that the selected code is correct.

According to one embodiment the method comprises:

analyzing the sequential structure of said plurality of digits,

determining, from the sequential structure of the digits, in which country the plurality of digits relate to a subscriber number,

wherein said creation of the international telecommunication number is performed by reading a country code, corresponding to the country in which the plurality of digits relate to a subscriber number, from the memory in the mobile telecommunication terminal and adding the country code to the plurality of digits.

The method hence provide an international telecommunication number even if there is no location information available.

According to another aspect of the invention a mobile telecommunication terminal comprises a control unit adapted to receive a plurality of digits and determine if one or more of the plurality of digits correspond to a country code, wherein the control unit is further adapted to create an international telecommunication number, if the one or more of the plurality of digits do not correspond to a country code, by adding a country code to the plurality of digits.

A third aspect of the invention relates to a method for controlling a mobile telecommunication terminal, said method comprising:

transferring a plurality of digits from the mobile telecommunication terminal to a base station in order to set up a communication to the subscriber terminal,

receiving a confirmation signal from the base station, said confirmation signal indicating that a communication has been established between the mobile telecommunication terminal and the subscriber terminal,

creating the international telecommunication number in the mobile telecommunication terminal by associating a country code with the received plurality of digits in response to said confirmation signal and

storing the international telecommunication number in the memory.

A successful communication implies that the received digits in fact are a valid telecommunication number. The creation of the international telecommunication number is hence based on a valid telecommunication number.

According to one embodiment the plurality of digits are received in an input unit in the mobile telecommunication terminal.

According to one embodiment the plurality of digits are read from a memory in the mobile telecommunication terminal.

According to one embodiment said association of a country code is performed by adding the country code to the received plurality of digits. A complete international telecommunication number is hence stored in the memory which simplifies the implementation of the method.

A fourth aspect of the present invention relates to a mobile telecommunication terminal comprising:

a memory,

a transceiver adapted to transfer a subscriber number, identifying a subscriber terminal in a telecommunication network, from the mobile telecommunication terminal to a base station in order to set up a communication to the subscriber terminal, and receive a confirmation signal from the base station, said confirmation signal indicating that a communication has been established between the mobile telecommunication terminal and the subscriber terminal, and

a control unit adapted to create an international telecommunication number by associating a country code with the previously read subscriber number in response to said confirmation signal and store the international telecommunication number in the memory.

A fifth aspect of the present invention relates to a method for storing an international telecommunication number in a memory in a mobile telecommunication terminal, said method comprising:

receiving a plurality of digits in a control unit in the mobile telecommunication terminal, said digits identifying a subscriber terminal in a telecommunication network,

determining if one or more of the plurality of digits correspond to a country code,

if the one or more of the plurality of digits do not correspond to a country code, determining in which country the mobile telecommunication terminal is located and creating an international telecommunication number by associating a country code, corresponding to the country in which the mobile telecommunication terminal is located, with the plurality of digits, and

storing the international telecommunication number in the memory.

A person who wants to store a telecommunication number is very often located in the country in which the telecommunication number is valid. The method according to the fifth aspect of the present invention will consequently facilitate a correct formatting of the telecommunication number.

A sixth aspect of the invention relates to a mobile telecommunications terminal comprising:

a memory,

an input unit adapted to receive a plurality of digits identifying a subscriber terminal in a telecommunication network; and

a control unit adapted to:

determine if one or more of the plurality of digits correspond to a country code

create an international telecommunication number, if the one or more of the plurality of digits do not correspond to a country code, by associating a country code, corresponding to the country in which the mobile telecommunication terminal is located, with the plurality of digits, and

store the international telecommunication number in the memory.

A seventh aspect of the invention relates to a method for storing an international telecommunication number in a memory in a mobile telecommunication terminal, said method comprising:

receiving a plurality of digits in a control unit in the mobile telecommunication terminal, said digits identifying a subscriber terminal in a telecommunication network,

determining if one or more of the plurality of digits correspond to a country code; and

if the one or more of the plurality of digits do not correspond to a country code, create an international telecommunication number by:

analyzing the sequential structure of said plurality of digits,

determining, from the sequential structure of the digits in which country the plurality of digits relate to a subscriber number,

reading a country code corresponding to the country in which the plurality of digits relate to a subscriber number from the memory in the mobile telecommunication terminal and adding the country code to the plurality of digits, and

storing the international telecommunication number in the memory.

The method hence makes it possible to store a correctly formatted international telecommunication number even if location information is unavailable for determining which country code to add.

### BRIEF DESCRIPTION OF THE DRAWINGS

Further objects, features and advantages of the present invention will become apparent upon consideration of the following detailed description in conjunction with the appended drawings.

FIG. 1 illustrates a mobile telecommunication terminal according to the present invention.

FIG. 2 is a schematic graph illustrating a method for providing an international telecommunication number to a base station according to a first aspect of the present invention.

FIG. 3 is a schematic graph illustrating a method for storing an international telecommunication number in a mobile telecommunication terminal according to a second aspect of the present invention.

FIG. 4 is a schematic graph illustrating a method for storing an international telecommunication number according to a third aspect of the present invention.

FIG. 5 is a schematic graph illustrating a method for storing an international telecommunication number according to a fourth aspect of the present invention.

### DETAILED DESCRIPTION OF THE PREFERRED EMBODIMENT(S)

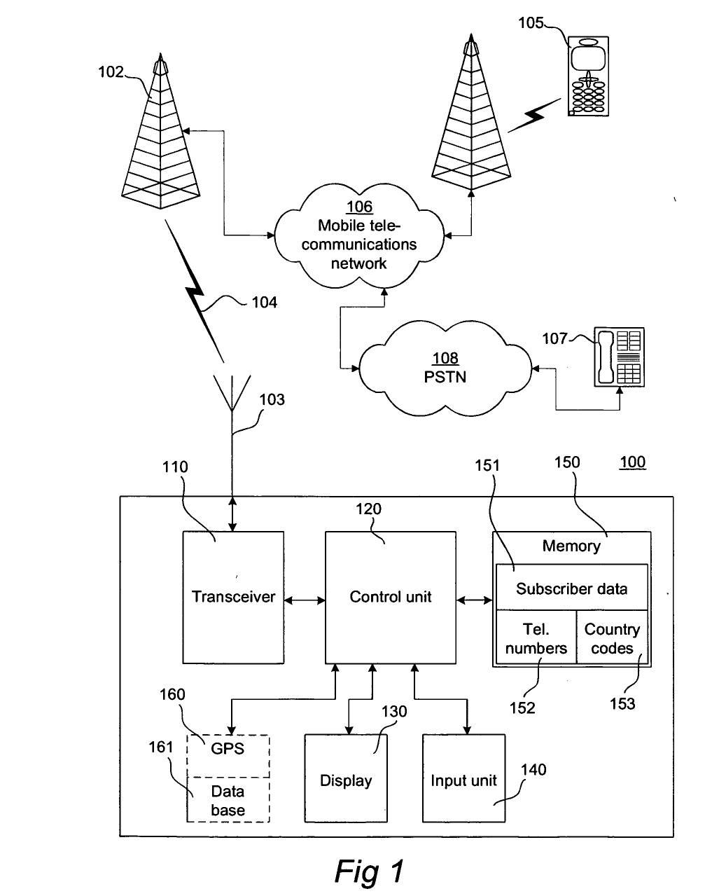

FIG. 1 is a schematic block diagram of a mobile telecommunication terminal 100 according to a preferred embodiment of the present invention. A transceiver 110 is communicating with a base station 102 via an antenna 103 and a first wireless communication link 104. The base station 102 is in communication with other mobile telecommunication terminals 105 via a mobile communications network 106, and stationary terminals 107 via e.g. a public switched telephone network (PSTN) 108. The transceiver 110 may be arranged to operate in various frequency bands, such as 880-915 MHz and 925-960 MHz (GSM900), 1710-1785 MHz and 1805-1880 MHz (GSM1800), 1850-1910 MHz and 1930-1990 MHz (GSM1900), and 1885-2025 MHz and 2110-2200 MHz (UMTS). It is appreciated that other frequency bands are equally possible depending on the specifications of the network in which the mobile telecommunication terminal 100 is to operate.

A controller 120 is coupled to the transceiver 110. The controller 120 may comprise signal processing circuitry in order to process e.g. voice data from a user of the mobile telecommunication terminal 100 and provide the transceiver 110 with the data for transmission to the base station 102. Likewise, the controller 120 may comprise signal processing circuitry for processing data received from the other telecommunication terminals 105, 107 in order to provide the user of the mobile telecommunication terminal 100 with e.g. audio, image or video data. Alternatively (not shown) some or all of the signal processing functionality may be provided by specialized circuitry in the mobile telecommunication terminal 100.

The controller 120 is coupled to a display 130 for providing a user of the mobile telecommunication terminal 100 with visual data regarding e.g. a specific call in progress, telecommunication numbers stored in the mobile telecommunication terminal 100, signal strength of the wireless communication link 104, messages received from other mobile telecommunication terminals 105, etc.

The controller 120 is moreover coupled to an input unit 140, which may be in the form of a keyboard; an on-screen touch-sensitive keyboard; a navigation wheel or joystick for scrolling and selecting items, digits and/or characters shown on the display 120; etc. The input unit 140 may be integral with the mobile telecommunication terminal 100 or separate from the mobile telecommunication terminal 100, wherein the input unit is connected to the mobile telecommunication terminal when needed. The mobile telecommunication terminal 100 may alternatively be provided with an integral input unit 140 in the form of a navigation wheel for normal use as well as a connector for connecting an external input unit in the form of a keyboard for entering larger amounts of text (not shown).

A memory 150 is connected to the controller 120 and comprises subscriber data 151 which identifies the user of the mobile telecommunication terminal 100 to the mobile telecommunications network service provider. If the mobile telecommunication terminal 100 is used in e.g. a UMTS or GSM system, the subscriber data are preferably stored on a SIM card (not shown) in addition to in the memory 110.

Moreover, a user of the mobile telecommunication terminal 100 may store a list of telecommunication numbers 152 in the memory 150 in order to facilitate the procedure of establishing communications with other terminals 105, 107. A user of the mobile telecommunication terminal 100 may use the list 152 for storing telecommunication numbers in different formats, i.e. the telecommunication numbers may be stored as subscriber numbers or international telecommunication numbers according to the discussion above.

The memory 150 also comprises a list of country codes 153 assigned to different countries according to the ITU recommendation E.164. Since the memory is connected to both the transceiver 110 and the display 130 via the controller 120, a specific country code may be transferred from the memory 150 to the base station 102, or the name of a country corresponding to the country code may be displayed on the display 130.

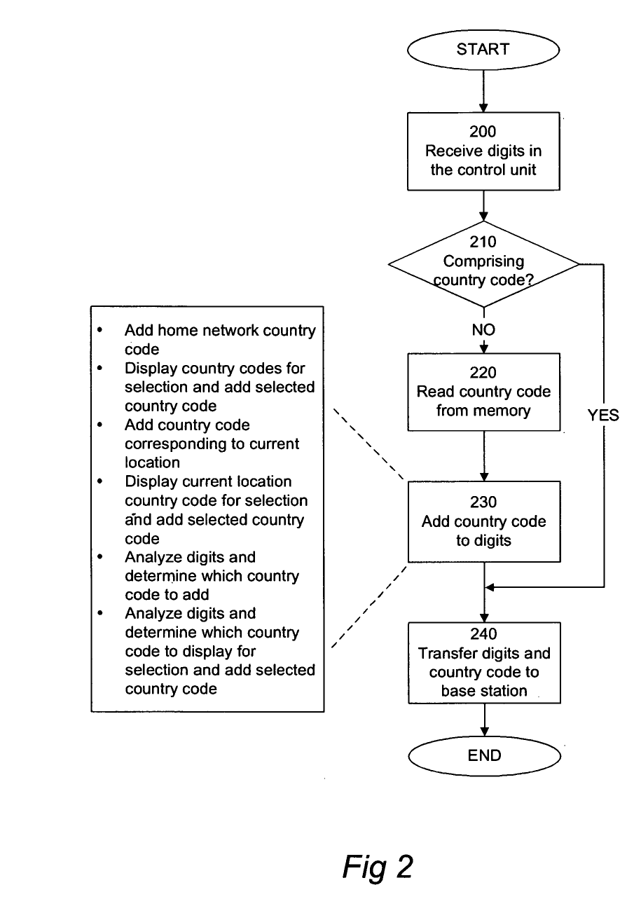

FIG. 2 is a schematic graph illustrating a method for providing an international telecommunication number to a base station 102 according to a first aspect of the present invention. In this embodiment the control unit 120 in step 200 receives digits, which identifies a subscriber terminal 105, 107 in a telecommunication network, from either the input unit 140 or the memory 150. In the former case the user of the mobile telecommunication terminal 100, when he or she wants to establish a communication with another terminal 105, 107, inputs a series of digits on the input unit 140 by e.g. pressing the appropriate keys on a keyboard or selecting the digits by means of a navigation wheel and the display 130. In the latter case the user selects a pre-stored telecommunication number from the list of telecommunication numbers 152 in the memory. If the digits only correspond to a subscriber number it is appreciated that the same digits may identify two different subscriber terminals in two different networks.

If the digits are read from the memory and received in the control unit, the user does not have to remember the specific digits. The telecommunication numbers in the list 152 are preferably associated with the name of a person or company, wherein the name rather than the numbers are displayed for selection the display 130.

The control unit 120 then in step 210 determines if one or more of the digits entered by means of the input unit 140 or read out of the memory 150 correspond to a country code. A simple and straightforward method for determining if the digits comprise a country code is to compare the first digits in the received sequence of digits with the country codes 153 stored in the memory 150. More complex schemes taking the structure of the entire sequence of digits into account is, however, equally possible.

If it is determined that the sequence of digits comprises a country code the routine jumps to step 240, wherein the digits and the country code are sent to the base station 102 in order to establish a communication with another terminal 105, 107. If, however, it is determined that the digits do not comprise a country code, the control unit 120 in step 220 reads a country code 153 from the memory 150 and in step 230 adds the country code 153 to the plurality of digits. In order to do so, the control unit 120 reads out subscriber data 151 from the memory 150 so as to determine which home network the mobile telecommunication terminal 100 (or its SIM card in e.g. GSM and UMTS systems) is associated with. The control unit 120 may then create an international telecommunication number by adding, to the sequence of digits, the country code corresponding to the country in which the home network is located. Alternatively the user of the mobile telecommunication terminal 100 may have selected a specific country code as a default code, wherein the control unit 120 automatically adds the default code to the sequence of digits.

In an alternative embodiment the control unit may use the display 130 for presenting data identifying one or more countries corresponding to one or more country codes 153 in the memory 150. The user may then select the country to which he or she wants to direct the call, wherein the control unit 120 adds, to the received digits, the country code corresponding to the selected country.

In yet an alternative embodiment the control unit may via the transceiver 110 first determine in which country the mobile telecommunication terminal is located by receiving a network ID form the base station 102. In case of e.g. GSM, the network ID comprises a mobile country code as defined in ITU recommendation E.212, wherein the control unit 120 directly from the information received may determine in which country the mobile telecommunication terminal 100 is currently located. Alternatively, the control unit 120 may be coupled to a GPS receiver 160 and a database 161, comprising country location information, in order to establish the current position of the mobile telecommunication terminal 100. The GPS database 161 preferably directly provides the control unit 120 with a mobile country code corresponding to the current location of the mobile telecommunication terminal 100.

The mobile country code of the home network provided by means of the subscriber data 151 is then compared to the mobile country code received from the base station 102 or the GPS database 161 in order to determine if the current location of the mobile telecommunication terminal 100 corresponds to the country of the home network. If the location data relating to the mobile telecommunication terminal 100 do not match the country of home network, the control unit 120 creates an international telecommunication number by adding the country code, corresponding to the country in which the mobile telecommunication terminal is currently located, to the digits received in step 200. Alternatively, the control unit 120 may use the display 130 for presenting data identifying the country corresponding to the mobile country code received form the base station 102 or the GPS database 161. The user may then select to which country he or she wants to direct the call whereupon the control unit 120 creates an international telecommunication number by adding the country code of the specified country to the digits received in step 200.

In yet an alternative embodiment the control unit analyzes the sequential structure of the sequence of digits received in step 200. The analyze is preferably based on the numbering structure found in ITU recommendation E.164. By comparing the sequential structure of the received digits with the different numbering structures found in different countries, the control unit may determine in which country the plurality of digits relate to a subscriber number. The control unit 120 then creates an international telecommunication number by adding the country code, corresponding to the country in which the plurality of digits relate to a subscriber number, to the digits received in step 200. Alternatively, the control unit 120 may use the display 130 for presenting data identifying the country in which the plurality of digits relate to a subscriber number. The user may then select the country whereupon the control unit 120 creates an international telecommunication number by adding the country code to the digits received in step 200.

In yet an alternative embodiment, the country code is coded in hardware in the mobile telecommunication terminal 100, wherein the control unit only has one specific country code to add to the received digits. The country code coded in hardware in the mobile telecommunication terminal 100 may e.g. be the country code corresponding to the country of the home network.

As mentioned above, in step 240 the control unit 120 via the transceiver 110 transfers the international telecommunication number to the base station 102 in order to establish a communication with another terminal 105, 107.

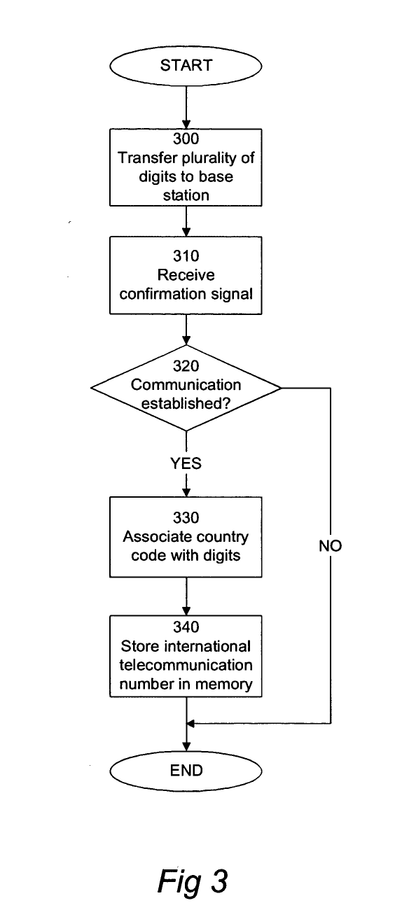

FIG. 3 is a schematic graph illustrating a method for storing an international telecommunication number in a mobile telecommunication terminal 100 according to a second aspect of the present invention. As disclosed above, the user of the mobile telecommunication terminal 100, when he or she wants to establish a communication with another terminal 105, 107, inputs a series of digits on the input unit 140 by e.g. pressing the appropriate keys on a keyboard or selecting the digits by means of a navigation wheel and the display 130. Alternatively the user selects a pre-stored telecommunication number from the list of telecommunication numbers 152 in the memory. After the user has selected which number to call, the control unit 120 transfers the plurality of digits to the base station 102 via the transceiver 110.

When the base station 102 has established a connection between the mobile telecommunication terminal 100 and another subscriber terminal 105, 107, it transfers a confirmation signal to the mobile telecommunication terminal 100. The confirmation signal indicates that a communication has been established between the mobile telecommunication terminal and the subscriber terminal. In case the transferred number does not exist in the current network or is erroneous in any other way, the confirmation signal indicates that it not possible to establish a communication between the mobile telecommunication terminal 100 and the other subscriber terminal 105, 107.

In step 320 the control unit 120 determines if a communication is successfully established between the mobile telecommunication terminal 100 and the other subscriber station. If not, the routine ends and no new number is stored in the memory 150. However, if a communication is established, the routine jumps to step 330, wherein the control unit 120 creates the international telecommunication number by associating a country code with the received plurality of digits in response to the confirmation signal. The association may be in the form of a pointer which links a country code 153 stored in the memory 150 with a telecommunication number (subscriber number) 152 also stored in the memory. If the telecommunication number used for establishing a communication between the mobile telecommunication terminal 100 and the other subscriber station 105, 107 is not present in the memory 150, i.e. the user has used the input unit for providing the digits, the control unit stores the digits in the memory 150 prior to associating them with a country code. In step 340 the control unit 120 stores the international telecommunication number in the memory 150 by simply storing the pointer to the country code. Alternatively, the control unit 120 creates the international telecommunication number by adding the country code to the digits in accordance with the ITU recommendation E.164 prior to storing the entire international telecommunication number in the memory 150, where it replaces the old telecommunication number.

The selection of which country code to add to or associate with the received digits is preferably performed in that the control unit determines in which country the mobile telecommunication terminal is located by receiving a network ID form the base station 102 or via a GPS receiver 160 and a database 161 and creates an international telecommunication number by adding the country code, corresponding to the country in which the mobile telecommunication terminal is currently located, to the digits. Alternatively, the control unit 120 may use the display 130 for presenting data identifying the country corresponding to the mobile country code received form the base station 102 or the GPS database 161. The user may then select the country whereupon the control unit 120 creates an international telecommunication number by adding the country code, corresponding to the country in which the mobile telecommunication terminal is currently located, to the digits.

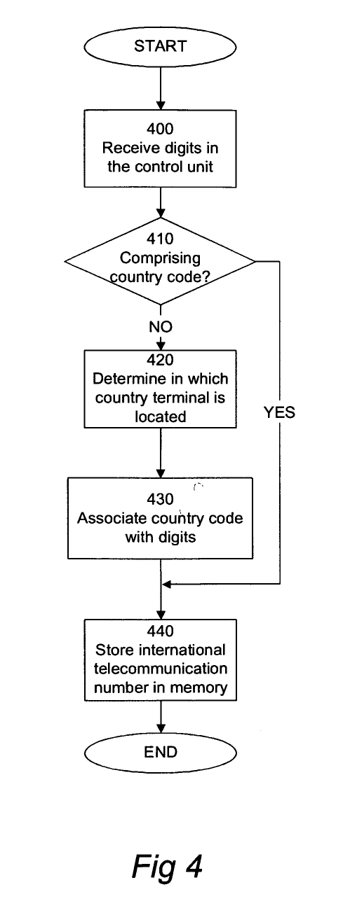

FIG. 4 is a schematic graph illustrating a method for storing an international telecommunication number according to a third aspect of the present invention.

In step 400 the user of the mobile telecommunication terminal 100 inputs a series of digits on the input unit 140 by e.g. pressing the appropriate keys on a keyboard or selecting the digits by means of a navigation wheel and the display 130. Alternatively the user selects digits in the form of a pre-stored telecommunication number from the list of telecommunication numbers 152 in the memory.

The control unit 120 then in step 410 determines if one or more of the digits entered by means of the input unit 140 or read out of the memory 150 corresponds to a country code. As mentioned above, a simple and straightforward method for determining if the digits comprise a country code is to compare the first digits in the received sequence of digits with the country codes 153 stored in the memory 150. More complex schemes taking the structure of the entire sequence of digits into account is, however, equally possible. If the digits comprise a country code the routine jumps to step 440, wherein the international telecommunication number is stored in the memory.

However, if it is determined that the digits do not comprise a country code, the control unit in step 420 determines in which country the mobile telecommunication terminal 100 is located by receiving a network ID form the base station 102 or via a GPS receiver 160 and a database 161 in accordance with the disclosure of step 330 above.

In step 430 the control unit 120 creates the international telecommunication number by associating the country code corresponding to the country in which the mobile telecommunication terminal 100 is currently located with the received plurality of digits. The association may be in the form of a pointer which links a country code 153 stored in the memory 150 with a telecommunication number (subscriber number) 152 also stored in the memory. If the received digits are input by means of the input unit, the control unit 120 stores the digits in the memory 150 prior to associating them with a country code.

In step 440 the control unit 120 stores the international telecommunication number in the memory 150 simply by storing the pointer to the country code. Alternatively, the control unit 120 creates the international telecommunication number by adding the country code to the digits in accordance with the ITU recommendation E.164 prior to storing the entire international telecommunication number in the memory 150.

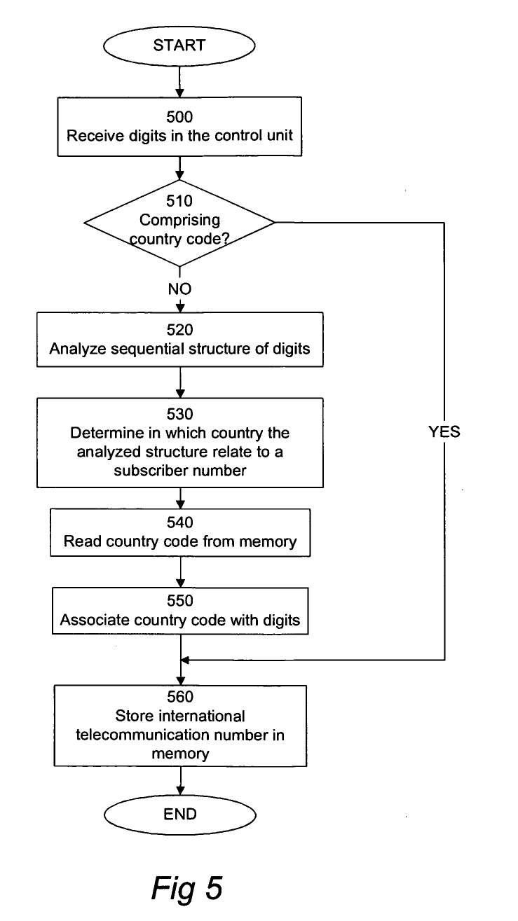

FIG. 5 is a schematic graph illustrating a method for storing an international telecommunication number according to a fourth aspect of the present invention. In step 500 the user of the mobile telecommunication terminal 100 inputs a series of digits on the input unit 140 by e.g. pressing the appropriate keys on a keyboard or selecting the digits by means of a navigation wheel and the display 130. Alternatively the user selects digits in the form of a pre-stored telecommunication number from the list of telecommunication numbers 152 in the memory.

The control unit 120 then in step 510 determines if one or more of the digits entered by means of the input unit 140 or read out of the memory 150 corresponds to a country code. As mentioned above, a simple and straightforward method for determining if the digits comprise a country code is to compare the first digits in the received sequence of digits with the country codes 153 stored in the memory 150. More complex schemes taking the structure of the entire sequence of digits into account is, however, equally possible. If the digits comprise a country code the routine jumps to step 560, wherein the international telecommunication number is stored in the memory 150.

If it is determined that the sequence of digits do not comprise a country code the control unit, in step 520, analyzes the sequential structure of the sequence of digits received in step 500. The analyze is preferably based on the numbering structure found in ITU recommendation E.164. By comparing the sequential structure of the received digits with the different numbering structures found in different countries, the control unit 120 may, in step 530, determine in which country the plurality of digits relate to a subscriber number.

In step 540 the control unit then reads a country code from the memory 150, which code corresponds to the country in which the plurality of digits relate to a subscriber number.

The control unit 120 then, in step 550, creates an international telecommunication number by associating the country code, corresponding to the country in which the plurality of digits relate to a subscriber number, to the digits received in step 500. Alternatively, the control unit 120 may use the display 130 for presenting data identifying the country in which the plurality of digits relate to a subscriber number. The user may then select the country whereupon the control unit 120 creates an international telecommunication number by associating the country code to the digits received in step 500. The association may be in the form of a pointer which links a country code 153 stored in the memory 150 with a telecommunication number (subscriber number) 152 also stored in the memory. If the received digits are input by means of the input unit, the control unit 120 stores the digits in the memory 150 prior to associating them with a country code.

In step 560 the control unit 120 stores the international telecommunication number in the memory 150 simply by storing the pointer to the country code. Alternatively, the control unit 120 creates the international telecommunication number by adding the country code to the digits in accordance with the ITU recommendation E.164 prior to storing the entire international telecommunication number in the memory 150.

The present invention is very useful in relation to message signaling, such as Short Messaging Service (SMS), Enhanced Messaging Service (EMS) or Multimedia Messaging Service (MMS). Normally the message signaling is handled by a home server, wherein it is of most importance that the message is sent from the mobile telecommunication terminal 100 to the correct country, i.e. the home network country, from which the message then may be sent to the destination terminal 105, 107.

While the present invention has been particularly shown and described with reference to specific embodiments thereof, it will be understood by those skilled in the art that various changes in form and detail may be made thereto, and that other embodiments of the present invention beyond embodiments specifically described herein may be made or practiced without departing from the spirit and scope of the present invention as limited solely by the appended claims.

1. A method for providing an international telecommunication number, comprising a plurality of digits corresponding to at least a country code, from a mobile telecommunication terminal to a base station, said method comprising:
receiving a plurality of digits in a control unit in the mobile telecommunication terminal, said digits identifying a subscriber terminal in a telecommunication network,
determining if one or more of the plurality of digits correspond to a country code,
if the one or more of the plurality of digits do not correspond to a country code, creating an international telecommunication number by adding a country code to the plurality of digits, and
transferring the international telecommunication number to the base station.

2. The method according to claim 1, wherein the country code is read from the memory in the mobile telecommunication terminal.

3. The method according to claim 1, wherein the control unit receives the digits from a memory in the mobile telecommunication terminal.

4. The method according to claim 1, wherein the control unit receives the digits from an input unit, such as a keyboard, in the mobile telecommunication terminal.

5. The method according to claim 1, wherein the mobile telecommunication terminal is associated with a subscription of services from a home network, said method comprising:
determining in which country the mobile telecommunication terminal is located
determining if the current location of the mobile telecommunication terminal corresponds to the country of the home network,
wherein said creation of the international telecommunication number is performed only if the current location of the mobile telecommunication terminal does not correspond to the country of the home network.

6. The method according to claim 3, wherein said creation of the international telecommunication number is performed by reading a default country code from the memory in the mobile telecommunication terminal and adding said country code to the plurality of digits.

7. The method according to claim 5 comprising:
determining in which country the mobile telecommunication terminal is located by means of a satellite navigation system, such as GPS (Global Positioning System) or Galileo.

8. The method according to claim 5 comprising:
receiving a mobile telecommunication network ID from a base station, and
determining in which country the mobile telecommunication terminal is located by means of the received mobile telecommunication network ID.

9. The method according to claim 1 comprising:
presenting, on a display on the mobile telecommunication terminal for selection, data identifying one or more countries corresponding to one or more country codes if it is determined that the telephone number does not comprise a country code.

10. The method according to claim 1 comprising:
analyzing the sequential structure of said plurality of digits,
determining, from the sequential structure of the digits, in which country the plurality of digits relate to a subscriber number,
wherein said creation of the international telecommunication number is performed by reading a country code corresponding to the country in which the plurality of digits relate to a subscriber number from the memory in the mobile telecommunication terminal and adding the country code to the plurality of digits.

11. A mobile telecommunication terminal comprising:
a control unit adapted to receive a plurality of digits and determine if one or more of the plurality of digits correspond to a country code, wherein the control unit is further adapted to create an international telecommunication number, if the one or more of the plurality of digits do not correspond to a country code, by adding a country code to the plurality of digits.

12. A method for storing an international telecommunication number in a memory in a mobile telecommunication terminal, said method comprising:
transferring a plurality of digits from the mobile telecommunication terminal to a base station in order to set up a communication to the subscriber terminal,
receiving a confirmation signal from the base station, said confirmation signal indicating that a communication has been established between the mobile telecommunication terminal and the subscriber terminal,
creating the international telecommunication number in the mobile telecommunication terminal by associating a country code with the received plurality of digits in response to said confirmation signal, and
storing the international telecommunication number in the memory.

13. The method according to claim 12, wherein the plurality of digits are received in an input unit in the mobile telecommunication terminal.

14. The method according to claim 12, wherein the plurality of digits are read from a memory in the mobile telecommunication terminal.

15. The method according to claim 12, wherein said association of a country code is performed by adding the country code to the received plurality of digits.

16. A mobile telecommunication terminal comprising:
a memory,
a transceiver adapted to transfer a subscriber number, identifying a subscriber terminal in a telecommunication network, from the mobile telecommunication terminal to a base station in order to set up a communication to the subscriber terminal, and receive a confirmation signal from the base station, said confirmation signal indicating that a communication has been established between the mobile telecommunication terminal and the subscriber terminal, and
a controller adapted to create an international telecommunication number by associating a country code with the previously read subscriber number in response to said confirmation signal and store the international telecommunication number in the memory.

17. A method for storing an international telecommunication number in a memory in a mobile telecommunication terminal, said method comprising:
receiving a plurality of digits in a control unit in the mobile telecommunication terminal, said digits identifying a subscriber terminal in a telecommunication network,
determining if one or more of the plurality of digits correspond to a country code,
if the one or more of the plurality of digits do not correspond to a country code, determining in which country the mobile telecommunication terminal is located and creating an international telecommunication number by associating a country code, corresponding to the country in which the mobile telecommunication terminal is located, with the plurality of digits, and
storing the international telecommunication number in the memory.

18. The method according to claim 17 comprising:
determining in which country the mobile telecommunication terminal is located by means of a satellite navigation system, such as GPS (Global Positioning System) or Galileo.

19. The method according to claim 17 comprising:
receiving a mobile telecommunication network ID from a base station, and
determining in which country the mobile telecommunication terminal is located by means of the received mobile telecommunication network ID.

20. A mobile telecommunications terminal comprising:
a memory,
an input unit adapted to receive a plurality of digits identifying a subscriber terminal in a telecommunication network; and
a control unit adapted to:
determine if one or more of the plurality of digits correspond to a country code
create an international telecommunication number, if the one or more of the plurality of digits do not correspond to a country code, by associating a country code, corresponding to the country in which the mobile telecommunication terminal is located, with the plurality of digits, and
store the international telecommunication number in the memory.

21. A method for storing an international telecommunication number in a memory in a mobile telecommunication terminal, said method comprising:
receiving a plurality of digits in a control unit in the mobile telecommunication terminal, said digits identifying a subscriber terminal in a telecommunication network,
determining if one or more of the plurality of digits correspond to a country code; and
if the one or more of the plurality of digits do not correspond to a country code, create an international telecommunication number by:
analyzing the sequential structure of said plurality of digits,
determining, from the sequential structure of the digits in which country the plurality of digits relate to a subscriber number,
reading a country code corresponding to the country in which the plurality of digits relate to a subscriber number from the memory in the mobile telecommunication terminal and adding the country code to the plurality of digits, and
storing the international telecommunication number in the memory.
